(19) United States
(12) Patent Application Publication
(10) Pub. No.: US 2026/0298174 A1
(43) Pub. Date: Oct. 1, 2026

(54) PISTON COOLING ARRANGEMENT

(71) Applicant: CUMMINS INC., Columbus, IN (US)

(72) Inventors: Abhay Kumar Sahu, Pune (IN); Guna Pujitha, Pune (IN)

(73) Assignee: CUMMINS INC., Columbus, IN (US)

(21) Appl. No.: 19/562,513

(22) Filed: Mar. 10, 2026

(30) Foreign Application Priority Data
Mar. 29, 2025 (IN) 202541031145
Mar. 10, 2026 (IN) 202541031145

(51) Int. Cl. F02F 3/20

(52) U.S. Cl. CPC F02F 3/20

(57) ABSTRACT

A piston includes a skirt portion including a skirt sidewall centered about a piston center axis, and a crown portion positioned on an end of the skirt portion. The crown portion and the skirt portion cooperate to define a piston cavity. The crown portion includes a crown sidewall continuous with the skirt sidewall, a rim continuous with the crown sidewall and extending inward from the crown sidewall, an inner wall extending inward from the crown sidewall, and a bowl including a bowl wall extending from the rim to the inner wall. The crown sidewall, the rim, the inner wall, and the bowl wall cooperate to define a passageway extending around the bowl. The inner wall defines a channel extending at a non-zero angle relative to the piston center axis. The channel is in fluid receiving communication with the passageway and in fluid providing communication with the piston cavity.

### CROSS-REFERENCE TO RELATED APPLICATIONS

The present application claims priority to Indian Provisional Application No. 202541031145, filed Mar. 29, 2025 and to Indian Non-Provisional Application No. 202541031145, filed Mar. 10, 2026. The contents of these applications are incorporated herein by reference in their entireties.

### TECHNICAL BACKGROUND

The present application relates generally to pistons for an internal combustion engine system.

### BACKGROUND

Internal combustion engines include pistons that move within cylinders. Oil flows between an outer surface of each piston and an inner surface of each cylinder to facilitate the movement of the piston within the cylinder. Flow of oil within the piston gallery and the piston cavity facilitates cooling of the piston.

### SUMMARY

According to one embodiment, a piston includes a skirt portion including a skirt sidewall centered about a piston center axis, and a crown portion positioned on an end of the skirt portion. The crown portion and the skirt portion cooperate to define a piston cavity. The crown portion includes a crown sidewall that is continuous with the skirt sidewall, a rim that is continuous with the crown sidewall and extends radially inward from the crown sidewall, an inner wall extending radially inward from the crown sidewall, and a bowl. The bowl includes a bowl wall. The bowl wall extends from the rim to the inner wall. The crown sidewall, the rim, the inner wall, and the bowl wall cooperate to define a passageway extending around the bowl. The inner wall defines a channel extending at a non-zero angle relative to the piston center axis. The channel is in fluid receiving communication with the passageway and in fluid providing communication with the piston cavity.

### BRIEF DESCRIPTION OF THE DRAWINGS

The disclosure will become more fully understood from the following detailed description, taken in conjunction with the accompanying Figures, wherein like reference numerals refer to like elements unless otherwise indicated, in which:

FIG. 1 is a cross-sectional view of a portion of a piston for an internal combustion engine according to one embodiment;

FIG. 2 is a cross-sectional view of another portion of the piston according to the embodiment of FIG. 1;

FIG. 3 is a top view of a flow path within the piston according to the embodiment of FIG. 1;

FIG. 4 is another top view of the flow path within the piston according to the embodiment of FIG. 1;

FIG. 5 is a perspective view of a portion of the piston according to the embodiment of FIG. 1;

FIG. 6 is a cross-sectional view of a portion of a piston for an internal combustion engine according to another embodiment; and

FIG. 7 is a top view of a flow path within the piston according to the embodiment of FIG. 6.

It will be recognized that the Figures are schematic representations for purposes of illustration. The Figures are provided for the purpose of illustrating one or more implementations with the explicit understanding that the Figures will not be used to limit the scope or the meaning of the claims.

### DETAILED DESCRIPTION

Following below are more detailed descriptions of various concepts related to, and implementations of, methods, and apparatuses, of a piston cooling arrangement for an internal combustion engine. The various concepts introduced above and discussed in greater detail below may be implemented in any of a number of ways, as the described concepts are not limited to any particular manner of implementation. Examples of specific implementations and applications are provided primarily for illustrative purposes.

### I. Overview

Internal combustion engines (e.g., hydrogen, diesel, or gasoline internal combustion engines, etc.) utilize lubricant, such as oil, to facilitate repeated movement of pistons within cylinders. Internal combustion engines also use oil to cool or reduce the temperature of, the pistons within the cylinders and other portions of the engine system. To cool the pistons, oil is provided to the passageway (e.g., piston gallery, etc.) of the piston.

Implementations herein relate to a piston that includes a crown portion and a skirt portion that cooperate to define a piston cavity. The crown portion defines an internal passageway in fluid communication with at least one channel that provides flow to the piston cavity such that the flow contacts a portion of the connecting rod. The flow strikes the connecting rod or the pin and is directed upwards towards a piston under crown region (e.g., a bowl of the piston, an interior surface of the bowl, etc.).

Internal combustion engines with higher power ratings may produce higher combustion heat flux on the piston crown portion including the bowl, thus increasing its surface temperature. Providing flow towards the piston under crown region (e.g., the bowl, near and around the apex of the bowl, etc.) reduces the temperature of the bowl apex of piston and thus reducing physical stress on the piston. Reducing the temperature of the piston facilitates movement of the piston within the cylinder and reduces instances of reduction of power rating and instances of reduced engine performance.

### II. Internal Combustion Engine With Example Oil Ring Assembly

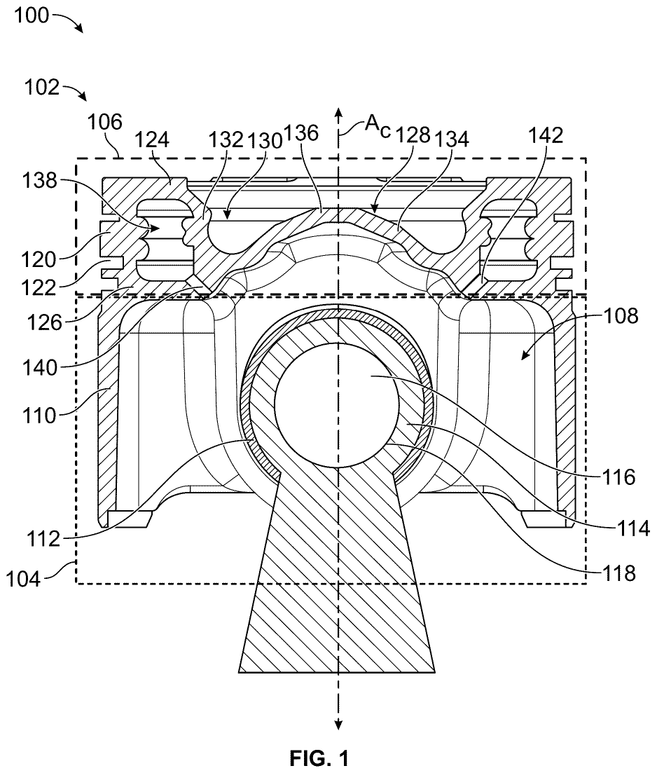

FIG. 1 depicts a cross-sectional view of a portion of a piston 102 for an internal combustion engine (e.g., diesel internal combustion engine, gasoline internal combustion engine, hybrid internal combustion engine, liquid natural gas internal combustion engine, propane internal combustion engine, hydrogen internal combustion engines, other fuel engines, etc.).

A piston 102 includes a skirt portion 104 including a skirt sidewall 110 centered about a piston center axis A_{C}, and a crown portion 106 positioned on an end of the skirt portion 104. The crown portion 106 and the skirt portion 104 cooperate to define a piston cavity 108. The crown portion 106 includes a crown sidewall 120 continuous with the skirt sidewall 110, a rim 124 continuous with the crown sidewall 120 and extending radially inward from the crown sidewall 120, an inner wall 126 extending radially inward from the crown sidewall 120, and a bowl 128 including a bowl wall 130. The bowl wall 130 extends from the rim to the inner wall 126. The crown sidewall 120, the rim 124, the inner wall 126, and the bowl wall 130 cooperate to define a passageway 138 extending around the bowl 128. The inner wall 126 defines a channel 140 extending at a non-zero angle relative to the piston center axis A_{C}. The channel 140 is in fluid receiving communication with the passageway 138 and in fluid providing communication with the piston cavity 108.

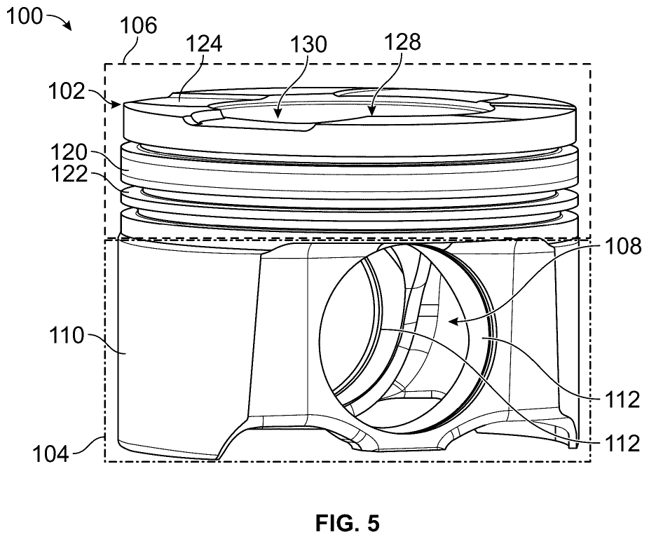

As shown in FIGS. 1-5, the internal combustion engine 100 includes the piston 102. The piston 102 is positioned in a cylinder bore of a cylinder block of the internal combustion engine. The piston 102 is configured to compress air and fuel within the cylinder block (e.g., within a combustion chamber, etc.), and converts the energy from the reaction of the air and the fuel to rotation energy to drive the engine.

The piston 102 includes the skirt portion 104 and the crown portion 106. The crown portion 106 is continuous with the skirt portion 104. Each of the skirt portion 104 and the crown portion 106 are positioned in the cylinder of the internal combustion engine and centered along a piston center axis A_{C}. The crown portion 106 is positioned on an end of the skirt portion 104 (e.g., an end adjacent to valves or a fuel injector of the internal combustion engine, etc.).

The skirt portion 104 and the crown portion 106 cooperate to define a piston cavity 108. The piston cavity 108 is substantially cylindrical in shape. The piston cavity 108 is configured to receive components of the engine system, such as a connection rod and pin as described in more detail below.

The skirt portion 104 includes a skirt sidewall 110. The skirt sidewall 110 is centered about the piston center axis A_{C}. The skirt sidewall 110 engages with an inner surface of a cylinder bore of the cylinder of the internal combustion engine. According to this embodiment, the skirt sidewall 110 is a substantially flat surface (e.g., does not include any recesses or grooves, etc.). In other embodiments, the skirt sidewall 110 defines one more skirt sidewall grooves circumferentially around the skirt sidewall 110 to receive and facilitate moving of oil within the cylinder bore.

The skirt sidewall 110 defines a plurality of openings 112. The plurality of openings 112 are substantially circular in shape. A first one of the plurality of openings 112 extends through a first portion of the skirt sidewall 110, and a second one of the plurality of openings 112 extends through a second portion of the skirt sidewall 110. For example, the plurality of openings 112 extend radially through the skirt sidewall 110 (e.g., a first one of the plurality of openings and a second one of the plurality of openings are centered along an axis perpendicular to the piston center axis A_{C}, etc.). The plurality of openings 112 are configured to receive components of the internal combustion engine as described in more detail below.

The piston 102 includes a connecting rod 114 and a pin 116. At least a portion of each of the connecting rod 114 and the pin 116 are positioned in the piston cavity 108. The connecting rod 114 is positioned in the piston cavity 108 and a portion of the connecting rod 114 extends out of the piston cavity 108 (e.g., extends downwards and is coupled to a crankshaft, etc.).

The connecting rod 114 defines a rod opening 118. The rod opening 118 is positioned on an end of the connecting rod 114 positioned in the piston cavity 108. The rod opening 118 is configured to receive a portion of the pin 116. For example, the pin 116 extends through a first one of the plurality of openings 112, through the rod opening 118, and through a second one of the plurality of openings 112. The pin 116 is configured to couple the connecting rod 114 to the skirt portion 104 of the piston 102. The connecting rod 114 is configured to drive or move the piston 102 within the cylinder bore.

The crown portion 106 also includes a crown sidewall 120. The crown sidewall 120 is continuous with the skirt sidewall 110. At least a portion of the crown sidewall 120 is configured to be in contact with the surface of the cylinder bore. The crown sidewall 120 is configured to move longitudinally along the surface of the cylinder bore.

According to this embodiment, the crown sidewall 120 defines one or more crown sidewall grooves 122. The crown sidewall grooves 122 are substantially cuboid shaped when viewed in a cross-sectional view. The crown sidewall grooves 122 are configured to receive an amount of oil and provide oil to the inner surface of the cylinder bore as the piston 102 moves within the cylinder bore along the piston center axis A_{c}.

The crown portion 106 also includes a rim 124. The rim 124 is continuous with the crown sidewall 120 and extends radially inward (e.g., toward the piston center axis A_{C}, etc.) from the skirt sidewall 110. For example, the rim 124 extends along a plane substantially perpendicular to the piston center axis A_{C}.

The crown portion 106 also includes an inner wall 126. The inner wall 126 extends radially inward from the crown sidewall 120. For example, the inner wall 126 extends along a plane substantially perpendicular to the piston center axis A_{C}. The inner wall 126 is substantially parallel to the rim 124. According to this embodiment, the inner wall 126 is continuous with each of the skirt sidewall 110 and the crown sidewall 120.

The crown portion 106 further includes a bowl 128. The bowl 128 is substantially curved (e.g., domed shaped, etc.). The bowl 128 and the rim 124 are configured to cooperate to compress air and/or fuel causing combustion as the piston 102 performs a combustion cycle.

The bowl 128 includes a bowl wall 130. A bowl wall first portion 132 of the bowl wall 130 extends from the rim 124 to the inner wall 126. A bowl wall second portion 134 of the bowl wall 130 defines a bowl apex 136. The bowl apex 136 is positioned along (e.g., centered along, etc.) the piston center axis A_{C}. At least a portion of the bowl wall first portion 132 of the bowl apex 136 is substantially parallel to the crown sidewall 120. The bowl wall second portion 134 of the bowl wall 130 extends from the bowl wall first portion 132 of the bowl wall 130 towards the piston center axis A_{C} (e.g., extends radially inward towards the piston center axis A_{C}, etc.). For example, the bowl wall second portion 134 of the bowl wall 130 includes an inner surface (e.g., a piston under crown region, etc.) that cooperates with the inner wall 126 and the skirt sidewall 110 to define the piston cavity 108.

Each of the crown sidewall 120, the rim 124, the inner wall 126, and the bowl 128 cooperate to define a passageway 138 (e.g., a piston gallery, a flow path within the piston 102, etc.). The passageway 138 extends around the bowl 128. For example, passageway 138 extends circumferentially around the crown portion 106 of the piston 102. The passageway 138 is configured to receive flow and provide (e.g., circulate, etc.) flow around the crown portion 106 to cool the crown portion 106 of the piston 102 (e.g., lower a surface temperature of the piston 102, etc.). The passageway 138 is also configured to facilitate cooling of the rim 124 of the crown portion 106 of the piston 102.

The inner wall 126 also defines the channel 140, i.e., a first channel. The first channel 140 extends at an angle B₁ relative to the piston center axis A_{C}. The angle B₁ can vary to be any substantially non-zero angle. For example, the first channel 140 may extend at the angle B₁ (e.g., a first angle, etc.) in a range between 30 degrees and 60 degrees inclusive relative to the center axis A_{C}. In particular embodiments, the first channel 140 extends at the angle B₁ in a range between 40 degrees and 50 degrees inclusive relative to the piston center axis A_{C}.

The first channel 140 is in fluid receiving communication with the passageway 138. The first channel 140 is also in fluid providing communication with the piston cavity 108 as described in more detail below. The first channel 140 is configured to provide flow (e.g., oil, etc.) to the piston cavity 108 to cool the bowl apex 136 of the bowl 128 of the piston 102.

The inner wall 126 also defines a second channel 142. The inner wall 126 defines the second channel 142 a distance away from the first channel 140. For example, the second channel 142 is positioned on a side of the inner wall 126 opposite (e.g., diametrically opposed to, etc.) the first channel 140. The second channel 142 extends at an angle B₂ (e.g., a second angle, etc.) from the inner wall 126. The angle B₂ can vary to be any substantially non-zero angle. For example, the second channel 142 may extend from the inner wall 126 at the angle B₂ in a range between 30 degrees and 60 degrees inclusive relative to the piston center axis A_{C}. In particular embodiments, the second channel 142 extends at the angle B₂ in a range between 40 degrees and 50 degrees inclusive relative to the piston center axis A_{C}.

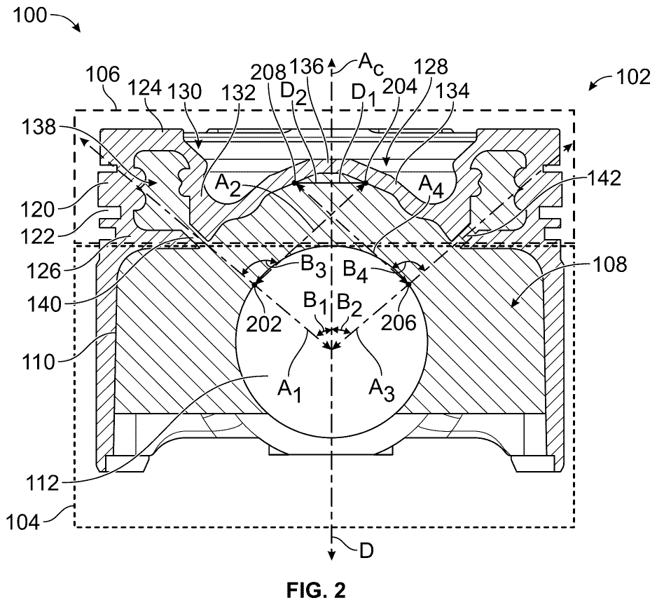

According to this embodiment, the second channel 142 is substantially similar to the first channel 140 in length, shape, and orientation. For example, as shown in FIGS. 1-2, the first channel 140 and the second channel 142 each may extend from the inner wall 126 at an angle (e.g., the angle B₁ or the angle B₂, etc.) of about 40 degrees to 50 degrees inclusive (e.g., 45 degrees, etc.). For example, the first channel 140 and the second channel 142 substantially mirror each other and extend at an angle of about 45 degrees relative to the piston center axis A_{C}. For example, each of the first channel 140 and the second channel 142 may have a diameter in a range between two millimeters and six millimeters (e.g., in a range of three millimeters to five millimeters, etc.).

As shown in FIG. 2, the first channel 140 provides flow along a first axis A₁. Flow along the first axis A₁ contacts the connecting rod 114 at a first contact point 202. At the first contact point 202, the flow along the first axis A₁ is directed along a second axis A₂. At least a portion of the flow directed along the second axis A₂ contacts an inner surface of the bowl 128 at a point 204 (e.g., a surface facing the piston cavity 108, etc.). Point 204 is a first distance D₁ away from the piston center axis A_{C}. For example, flow from the first channel 140 is in fluid providing communication with the piston cavity 108. The first axis A₁ extends along a center line of the flow provided by the first channel 140. The flow provided by the first channel 140 contacts the connecting rod 114 at and around the first contact point 202. At the first contact point 202, the connecting rod 114 directs flow along the second axis A₂ (e.g., a center line of the flow, etc.) to contact the bowl 128 at point 204. The contact of the flow at point 204 on the bowl 128 facilitates cooling of the bowl apex 136. The temperature of the bowl 128 of the piston 102 increases due to combustion (e.g., during higher power demand, etc.); thus it is advantageous to reduce the temperature of the bowl (e.g., the piston under crown region of the bowl, etc.) by providing flow throughout the crown portion 106 of the piston 102 (e.g., passageway 138, within the piston gallery, etc.).

It is advantageous to cool the bowl apex 136 of the piston 102 to facilitate movement of the piston 102 within the cylinder bore and decreases instances of reduced engine performance and/or power. The bowl apex 136 experiences an elevated temperature relative to, for example, the rim 124 (e.g., since the bowl apex 136 is positioned at a center of the combustion chamber, etc.), thus it is advantageous to provide flow around the bowl apex 136 to cool the bowl apex 136. Cooling the piston 102 including the bowl 128(e.g., the portion of the bowl wall 130 around the bowl apex 136, the piston under crown region, etc.) reduces the temperature of the piston 102 facilitating movement of the piston 102 within the cylinder bore. Decreasing the temperature of the piston 102 facilitates movement of the piston 102 (e.g., by reducing instances of expansion, etc.) and reduces instances of power reduction of the internal combustion engine. Further, cooling of the bowl apex 136 increases a lifespan of the piston 102 and performance of the piston 102 and the internal combustion engine 100.

The flow path from the first channel 140 along the first axis A₁ and the second axis A₂ defines a first flow path angle B₃ therebetween. For example, the second axis A₂ extends at the first flow path angle B₃ from the first axis A₁. The first flow path angle B₃ can vary to be any substantially non-zero angle. For example, the first flow path angle B₃ may be in a range between 85 degrees and 105 degrees inclusive (e.g., about 90 degrees in particular embodiments).

Similarly, the flow path from the second channel 142 along the third axis A₃ and the fourth axis A₄ defines a second flow path angle B₄ therebetween. For example, the fourth axis A₄ extends at the second flow path angle B₄ from the third axis A₃. The second flow path angle B₄ can vary to be any substantially non-zero angle. The second flow path angle B₄ is in a range between 85 degrees and 105 degrees inclusive (e.g., about 90 degrees in particular embodiments).

The second channel 142 provides flow along a third axis A₃. Flow along the third axis A₃ contacts the connecting rod 114 at a second contact point 206. At the second contact point 206, the flow along third axis A₃ is directed along a fourth axis A₄. At least a portion of the flow directed along the fourth axis A₄ contacts an inner surface of the bowl 128 at point 208 (e.g., a surface facing the piston cavity 108, etc.). Point 208 is a second distance D₂ away from the piston center axis A_{C}. For example, flow from the second channel 142 is in fluid providing communication with the piston cavity 108. The third axis A₃ extends along a center line of the flow provided by the second channel 142. The flow provided by the second channel 142 contacts the connecting rod 114 at and around the second contact point 206. At the second contact point 206, the connecting rod 114 directs flow along the fourth axis A₄ (e.g., a center line of the flow, etc.) to contact the bowl 128 at point 208. The contact of the flow at point 208 on the bowl 128 facilitates cooling of the bowl apex 136. As described above it is advantageous to cool the bowl apex 136 of the bowl 128 of the piston 102 to facilitate the movement of the piston 102 within the cylinder bore.

Each of the first channel 140 and the second channel 142 being in fluid providing communication with the piston cavity 108 at different positions along the inner wall 126 causes flow to strike or contact the connecting rod 114 at different points (e.g., at the first contact point 202 and the second contact point 206, etc.). By providing flow along the first axis A₁ and the second axis A₂ at an angle (e.g., an angle in a range between 40 degrees and 50 degrees inclusive, etc.) facilitates cooling of the bowl wall 130 around the bowl apex 136 increasing the lifespan of the piston 102.

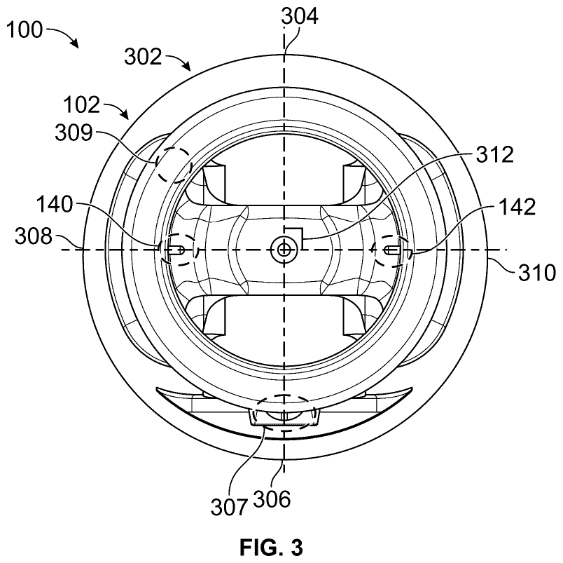

As shown in FIG. 3, the piston 102 is positioned in a cylinder bore 302. The cylinder bore 302 defines a front side 304 and a rear side 306. The rear side 306 is positioned opposite the front side 304. The cylinder bore 302 also defines a thrust side 308 (e.g., a side that receives force during the power stroke, etc.) and an anti-thrust side 310 (e.g., a side that receives force during the combustion stroke. The anti-thrust side 310 is positioned opposite the thrust side 308.

The piston 102 defines an inlet 307. The inlet 307 is positioned in the crown portion 106 adjacent to the front side 304 of the cylinder bore 302. The inlet 307 is in fluid providing communication with the passageway 138.

The piston 102 also defines an outlet 309. The outlet 309 is positioned in the crown portion 106 between the front side 304 and the thrust side 308. The outlet 309 is in fluid receiving communication with the passageway 138.

The first channel 140 is positioned on the thrust side 308 of the cylinder bore 302 and the second channel 142 is positioned on the anti-thrust side 310 the cylinder bore 302. The first channel 140 and the second channel 142 are defined by the inner wall 126 adjacent to the thrust side 308 and the anti-thrust side 310, respectively, provides flow along the shortest path to the bowl apex 136 of the bowl 128. For example, the flow path from each of the first channel 140 and the second channel 142 to the connecting rod 114 (e.g., to the first contact point 202 and the second contact point 206, etc.) and up to the bowl 128 around the bowl apex 136 (e.g., to points 204 and 208, etc.), is shorter in length than a flow path provided from a channel defined by the inner wall 126 adjacent to the front side 304 and the rear side 306.

Providing flow from the first channel 140 positioned on the thrust side 308 of the cylinder bore 302 and the second channel 142 positioned on the anti-thrust side 310 the cylinder bore 302 advantageously provides flow faster (e.g., in a shorter amount of time, etc.) to the bowl 128 reducing the amount of time needed to cool the bowl 128. For example, providing flow through the first channel 140 and the second channel 142 adjacent to the thrust side 308 and the thrust side 308 facilitates more rapidly cooling the bowl 128 than if the first channel 140 and the second channel 142 were positioned adjacent to the front side 304 and the rear side 306.

As previously described, flow from the first channel 140 is providing to the piston cavity 108 along the first axis A₁ and contacts or strikes the connecting rod 114 (e.g., at the first contact point 202, around the first contact point 202, etc.). The connecting rod 114 directs at least a portion of the flow along a second axis A₂ (e.g., a center axis of the flow, etc.) upwards to strike the bowl apex 136 at or around portion 312 of the bowl 128 cooling the bowl 128.

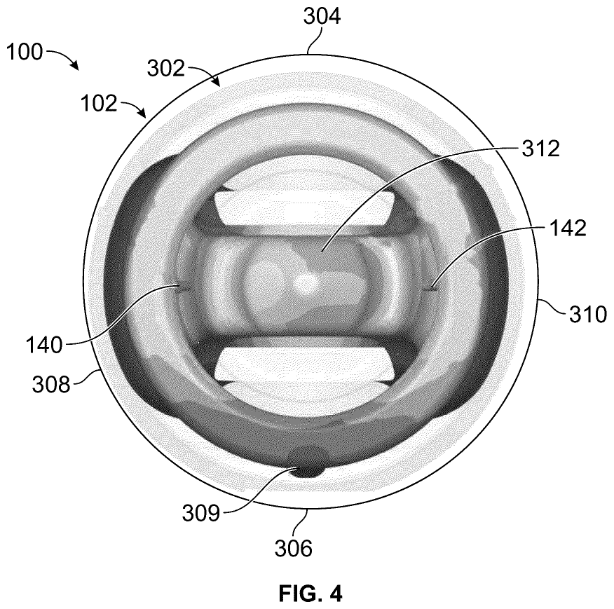

FIG. 4 is an example heat map of the rim 124 and the bowl 128. Flow from each of the first channel 140 and the second channel 142 facilitate cooling of the bowl 128, specifically around the bowl apex 136. For example, the first channel 140 and the second channel 142 facilitate a reduction of the temperature of the bowl 128 in a range between 57° C. and 59° C.

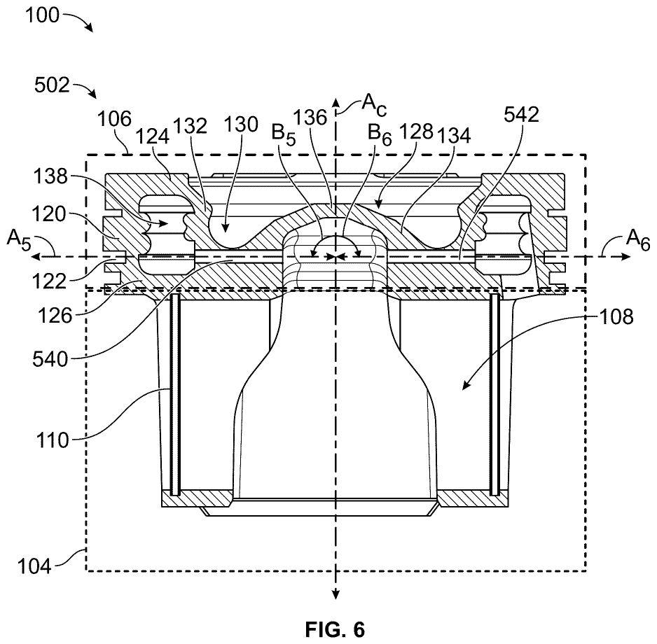

FIG. 6 is a cross-sectional view of a portion of the piston 502 for an internal combustion engine according to another embodiment. Similar to the embodiment of FIGS. 1-5, the inner wall 126 defines the first channel 540 and the second channel 542.

The inner wall 126 defines the first channel 540. The first channel 540 is centered along a fifth axis A₅. The fifth axis A₅ extends at an angle B₅ relative to the piston center axis A_{C}. The angle B₅ can vary to be any substantially non-zero angle. The angle B₅ is in a range between 85 degrees and 105 degrees inclusive relative to the piston center axis A_{C}. For example, the first channel 540 extends along the fifth axis A₅ substantially perpendicular to the piston center axis A_{C}.

The inner wall 126 defines the second channel 542. The second channel 542 is positioned on a side of the inner wall 126 substantially opposite the first channel 540 (e.g., when viewed in a cross-sectional view, etc.). The second channel 542 is centered along a sixth axis A₆. The sixth axis A₆ extends at an angle B₆ relative to the center axis A_{C}. The angle B₆ can vary to be any substantially non-zero angle. The angle B₆ is in a range between 85 degrees and 105 degrees inclusive relative to the piston center axis A_{C}. For example, the second channel 542 extends along the sixth axis A₆ substantially perpendicular to the piston center axis A_{C}.

Similar to the first channel 140 and the second channel 142, the first channel 540 and the second channel 542 are in fluid providing communication with the piston cavity 108. The reciprocal movement of the connecting rod 114 causes the flow from each of the first channel 540 and the second channel 542 to flow or slow upward in a direction towards the bowl apex 136 of the bowl 128 to facilitate cooling of the bowl 128.

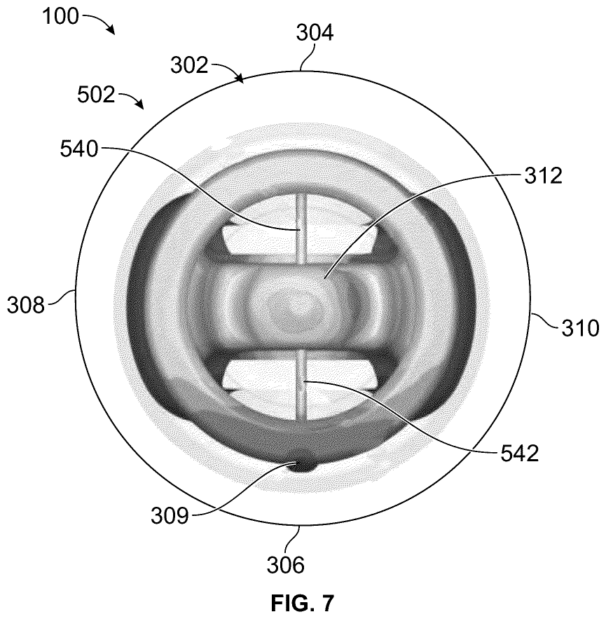

As shown in FIG. 7, the inner wall 126 defines the first channel 540 adjacent to the front side 304 of the cylinder bore 302. The inner wall 126 defines the second channel 542 adjacent to the rear side 306 of the cylinder bore 302 (e.g., on a side of the inner wall 126 substantially opposite the first channel 540, etc.). Flow from each of the first channel 540 and the second channel 542 is sloshed or directed upwards towards the bowl apex 136 of the bowl 128 via the reciprocal movement of the connecting rod 114. Providing flow to the surface of the bowl 128 around the bowl apex 136 advantageously cools the bowl 128. It is advantageous to provide flow around the bowl apex 136 to cool the bowl apex 136 since the bowl apex 136 often experiences the highest temperatures of the piston 502.

### Iv. Construction of Example Embodiments

While this specification contains many specific implementation details, these should not be construed as limitations on the scope of what may be claimed but rather as descriptions of features specific to implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a sub combination or variation of a sub combination.

As utilized herein, the terms “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the present disclosure.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

It is important to note that the construction and arrangement of the system shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the application, the scope being defined by the claims that follow. When the language “a portion” is used, the item can include a portion and/or the entire item unless specifically stated to the contrary.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W to P, etc.) herein are inclusive of their maximum values and minimum values (e.g., W to P includes W and includes P, etc.), unless otherwise indicated. Furthermore, a range of values (e.g., W to P, etc.) does not necessarily require the inclusion of intermediate values within the range of values (e.g., W to P can include only W and P, etc.), unless otherwise indicated.

What is claimed is:

1. A piston comprising:
a skirt portion comprising a skirt sidewall centered about a piston center axis; and
a crown portion positioned on an end of the skirt portion, the crown portion and the skirt portion cooperating to define a piston cavity, the crown portion comprising:
a crown sidewall continuous with the skirt sidewall,
a rim continuous with the crown sidewall and extending radially inward from the crown sidewall,
an inner wall extending radially inward from the crown sidewall, and
a bowl comprising a bowl wall, the bowl wall extending from the rim to the inner wall, the crown sidewall, the rim, the inner wall, and the bowl wall cooperating to define a passageway extending around the bowl,
wherein the inner wall defines a channel extending at a non-zero angle relative to the piston center axis, the channel in fluid receiving communication with the passageway and in fluid providing communication with the piston cavity.

2. The piston of claim 1, wherein the channel is a first channel extending at a first non-zero angle relative to the piston center axis, and wherein the inner wall defines a second channel extending at a second non-zero angle relative to the crown sidewall.

3. The piston of claim 2, wherein the second channel is positioned radially opposite the first channel relative to the piston center axis.

4. The piston of claim 1, wherein the non-zero angle is in a range between about 40 degrees and about 50 degrees inclusive relative to the piston center axis.

5. The piston of claim 1, wherein the skirt sidewall defines a plurality of openings extending radially through the skirt sidewall, and further comprising:
a connecting rod; and
a pin positioned though each of the plurality of openings and the connecting rod, the connecting rod causing flow provided by the channel to strike the bowl of the crown portion.

6. The piston of claim 1, wherein a diameter of the channel is in a range between about 2 millimeters and about 6 millimeters.

7. The piston of claim 1, wherein the skirt sidewall is a substantially flat surface free of recesses or grooves.

8. The piston of claim 1, wherein the inner wall is continuous with each of the skirt sidewall and the crown sidewall.

9. The piston of claim 1, wherein the bowl wall includes a bowl wall first portion extending from the rim to the inner wall and a bowl wall second portion defining a bowl apex positioned along the piston center axis.

10. An internal combustion engine, comprising:
an engine block defining a cylinder bore; and
the piston of claim 1 positioned within the cylinder bore, the skirt sidewall engaging with an inner surface of the cylinder bore.

11. The internal combustion engine of claim 10, wherein the skirt sidewall defines at least one skirt sidewall groove extending circumferentially around the skirt sidewall so as to receive and facilitate movement of oil within the cylinder bore.

12. The internal combustion engine of claim 10, wherein the crown sidewall defines at least one crown sidewall groove configured to receive an amount of oil and provide oil to the inner surface of the cylinder bore.

13. The internal combustion engine of claim 10, wherein the channel is a first channel extending at a first non-zero angle relative to the piston center axis and positioned on a thrust side of the cylinder bore, the thrust side of the cylinder bore receiving force during a power stroke, and wherein the inner wall defines a second channel extending at a second non-zero angle relative to the crown sidewall and positioned on an anti-thrust side of the cylinder bore opposite the thrust side, the anti-thrust side of the cylinder bore receiving force during a combustion stroke.

14. The internal combustion engine of claim 13, wherein the piston defines:
an inlet adjacent a front side of the cylinder bore, the inlet in fluid providing communication with the passageway; and
an outlet positioned between the front side of the cylinder bore and the thrust side of the cylinder bore, the outlet in fluid receiving communication with the passageway.

15. The internal combustion engine of claim 13, wherein the first channel and the second channel each extend at an angle between 85 degrees and 105 degrees inclusive relative to the piston center axis.

16. The internal combustion engine of claim 15, wherein at least one of the first channel and the second channel extends substantially perpendicular to the piston center axis.

17. The internal combustion engine of claim 13, wherein the first channel and the second channel each extend at an angle between 30 degrees and 60 degrees inclusive relative to the piston center axis.

18. The internal combustion engine of claim 10, wherein the skirt sidewall defines a plurality of openings extending radially through the skirt sidewall, and further comprising:
a connecting rod; and
a pin positioned though each of the plurality of openings and the connecting rod, the connecting rod causing flow provided by the channel to strike the bowl of the crown portion.

19. The internal combustion engine of claim 18, wherein the channel provides flow along a first axis A₁ to a contact point on the connecting rod, after which the flow is provided along a second axis A₂ so as to strike the bowl of the crown portion, the second axis A₂ extending at a flow path angle between 85 degrees and 105 degrees inclusive relative to the first axis A₁.

20. The internal combustion engine of claim 19, wherein:
the channel is a first channel, and wherein the inner wall defines a second channel extending at a second non-zero angle relative to the piston center axis, the second channel in fluid receiving communication with the passageway and in fluid providing communication with the piston cavity; and
the channel provides flow along a third axis A₃ to a contact point on the connecting rod, after which the flow is provided along a fourth axis A₄ so as to strike the bowl of the crown portion, the fourth axis A₄ extending at a flow path angle between 85 degrees and 105 degrees inclusive relative to the third axis A₃.
